(19) United States
(12) Patent Application Publication
(10) Pub. No.: US 2007/0049194 A1
(43) Pub. Date: Mar. 1, 2007

(54) System to combine antenna topologies to improve performance of satellite receivers

(75) Inventors: Jack H. King JR., Howell, MI (US); Richard D. Zerod, Chelsea, MI (US); Philip M. Bator, Farmington, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/218,139

(22) Filed: Sep. 1, 2005

(51) Int. Cl. H04H 1/00

(52) U.S. Cl. 455/3.02

(57) ABSTRACT

The present invention provides a system for receiving satellite signals. The system includes antennas, amplifiers, switching circuits, a combining circuit, and a tuner. The antennas provide a satellite signal to the amplifiers. The combining circuit selectively receives an amplified signal from the amplifier through the switching circuits. The combining circuit phase aligns the amplified signals received from the amplifiers and combines the amplified signals into a combined signal. Based on the combined signal, the tuner generates an audio signal.

### BACKGROUND

1. Field of the Invention

The present invention generally relates to a system to combine antenna topologies for a satellite receiver.

2. Description of Related Art

For a satellite radio system, the quality of the satellite signal received will vary greatly depending on antenna orientation and location. Conventional receiver systems have tried to address similar problems by changing the shape or orientation of the reception band of the antenna using steerable antenna methodologies. Other systems have incorporated multiple antennas where the antennas are switched such that the antenna with the best signal reception is connected to the tuner while the other antennas are isolated from the tuner. Although the above-described techniques have improved signal reception somewhat, further signal reception improvement is desirable.

Particularly in the case of satellite signals, the signal to noise ratio is quite low. In a mobile application, such as an in-vehicle receiver, the location and orientation of the antennas will be constantly changing adding to reception variability. In addition, vehicle styling requirements will also limit the size, location, and the number of antennas that can be located about the vehicle.

In view of the above, it is apparent that there exists a need for an improved satellite receiver system.

### SUMMARY

In satisfying the above need, as well as overcoming the enumerated drawbacks and other limitations of the related art, the present invention provides a system for receiving and combining satellite signals. The system includes antennas, amplifiers, switching circuits, a combining circuit, and a tuner. The antennas provide a satellite signal to the amplifiers. The combining circuit selectively receives an amplified signal from each amplifier through the switching circuits. Each switching circuit may be predictively configured based on environmental information received by the system. The combining circuit phase aligns the amplified signals received from the amplifiers and combines the amplified signals into a combined signal. Based on the combined signal, the tuner generates an audio signal.

In another aspect of the present invention, the system includes antennas, amplifiers, a first and second set of switching circuits, a first and second combining circuit, and a first and second tuner. The amplifiers provide an amplified signal to a corresponding switch circuit in each of the first and second set of switching circuits. The first set of switching circuits is in selective communication with the first combining circuit. Similarly, the second set of switching circuits is selectively in communication with the second combining circuit. The first and second set of switching circuits provides a unique combination of the amplified signals to each of the first and second combining circuit. The first and second combining circuits phase align each of the amplified signals that they receive from the switching circuits. The combining circuits then combine the amplified signals into a first and second combining signal. Each unique combination of amplified signals is determined based on signal characteristics of the first and second combined signals, as well as, environmental information. The first combining circuit provides a first combined signal to the first tuner, while the second combining circuit provides a second combined signal to the second tuner. The first and second tuner then provides a first and second output signal respectively to an evaluation circuit. The evaluation circuit generates an audio output signal based on an evaluation of the first and second output signals. In addition, the evaluation signal provides signal comparison information to a controller allowing the controller to manipulate the combination of amplified signals through the switching circuits.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a top view of a vehicle illustrating a satellite receiver system and possible antenna locations on the vehicle;

FIG. 2 is a side view of a satellite receiver system illustrating the desired reception band;

FIG. 3 is a diagrammatic view of a satellite receiver system in accordance with the present invention; and

FIG. 4 is a diagrammatic view of another embodiment of a receiver system in accordance with the present invention.

### DETAILED DESCRIPTION

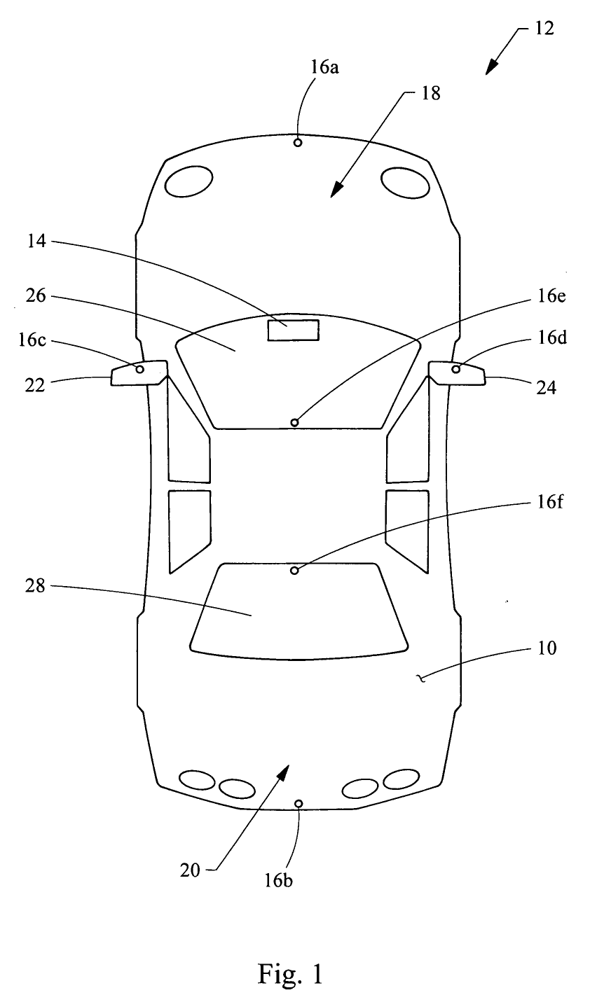

Referring now to FIG. 1, a vehicle 10 is illustrated. The vehicle 10 has a satellite receiver system 12 embodying the principles of the present invention. As its primary components, the satellite receiver system 12 includes a satellite receiver 14 and a plurality of antennas 16. The satellite receiver 14 is in electrical communication with the plurality of antennas 16 that are located at different positions around the vehicle 10. Each of the antennas 16 are located and oriented to provide a different reception band from which the satellite receiver 14 may receive satellite signals. The satellite receiver system 12 will have a desired reception band with a shape based on the satellite signal parameters defined by each satellite signal provider. For example, certain satellite signal providers have configured their satellite broadcast system such that optimal signal reception will be received if the reception band is oriented to receive signals from above 60° latitude. Other satellite signal providers may provide different configuration parameters that may affect the desired reception band.

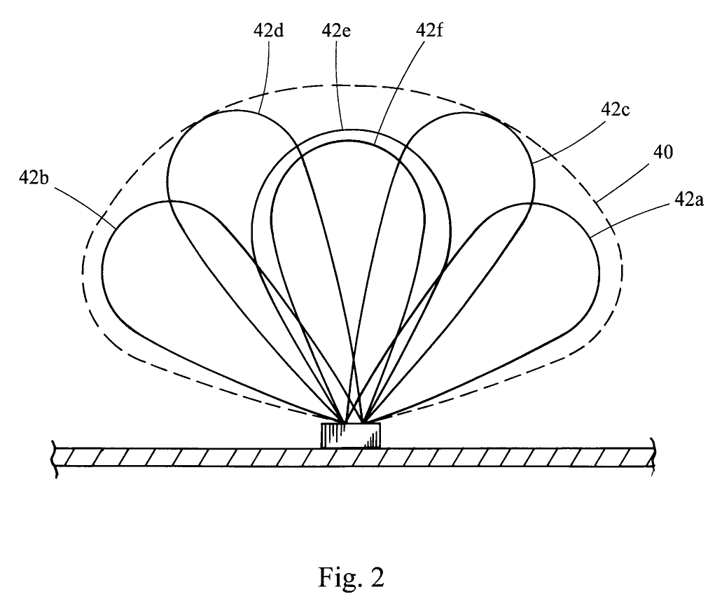

One potential desired reception band is illustrated in FIG. 2 and designated by reference numeral 40. Each antenna 16 is located and oriented to provide a reception band, such that the resulting reception band coverage (due to the overlap of each antenna's individual reception band) approximates the desired reception band 40. Accordingly, the antennas 16 are located around the vehicle 10 and are often situated in pairs.

Referring again to FIG. 1, antenna 16A is located in the front compartment 18 of the vehicle 10 and is configured to receive satellite signals broadcast from in front of the vehicle. Similarly, antenna 16B is located in the rear compartment 20 of the vehicle 10 and configured to receive satellite signals that are originated from behind the vehicle. Each of the antennas 16A and 16B may be located inside the front or rear compartment 18, 20 of the vehicle 10 to minimize any affect on the styling or appearance of the vehicle 10. Another pair of antennas may reside within the mirror housings 22, 24 of the vehicle 10. Antenna 16C is located in the left mirror housing 22 while antenna 16D is located within the right mirror housing 24. Again, locating the antennas 16C and 16D within the mirror housings 22, 24 allows the vehicle styling to be unaffected while providing a reception band on opposite sides of the vehicle 10 so that the satellite signal may be received whether the broadcast originates from the left side or right side of the vehicle 10. The antennas 16 may also be integrated into the windshield of the vehicle 10. For example, antenna 16E may be located on the front windshield 26 with a corresponding antenna 16F located on the rear windshield 28. Locating the antennas 16E, 16F on the windshield may allow the antenna to be oriented more vertically and with less obstruction than within the front or rear compartment 18, 20 or within one of the mirror housings 22, 24.

Referring again to FIG. 2, each of the antenna pairs from FIG. 1 cooperate to approximate the desired reception band 40. For example, antennas 16A and 16B may provide a reception band corresponding to 42A and 42B, with a substantially horizontal component. Likewise, antennas 16C and 16D are located within the mirror housings and may correspond to reception band 42C and 42D providing a more vertical component and extending in a different direction from reception bands 42A and 42B. Similarly, antennas 16E and 16F located on the windshield of the vehicle may correspond to reception band 42E and 42F providing an even greater vertical component although in different directions to approximate the desired reception band 40.

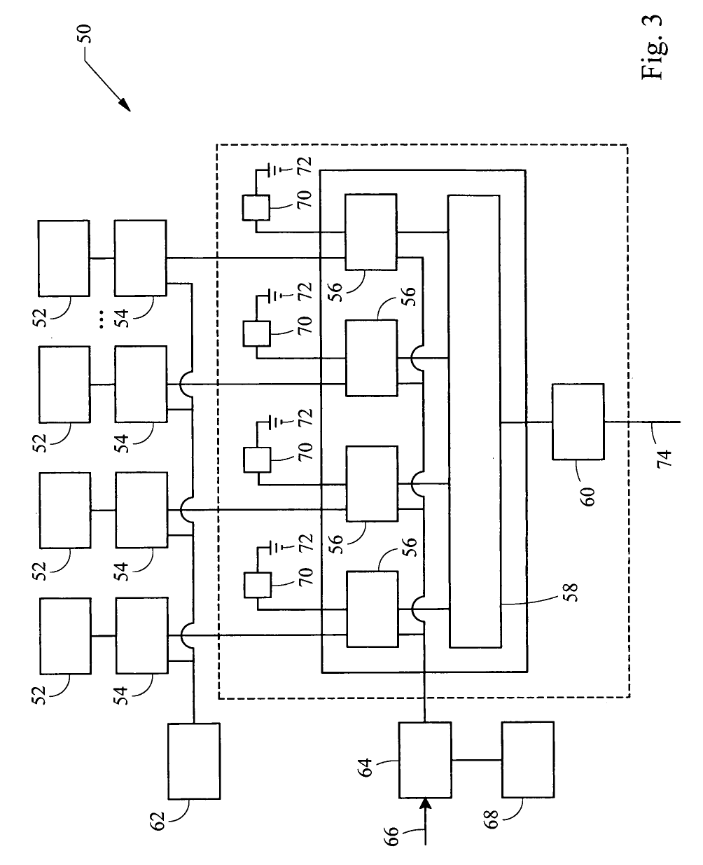

Now referring to FIG. 3, a satellite receiver system in accordance with the present invention is provided and designated by reference numeral 50. The satellite receiver system 50 includes a plurality of antennas 52, low noise amplifiers 54, switching circuits 56, a combining circuit 58, and a tuner 60. The antennas 52 are circularly polarized antennas and may be patch, quadra filar helix, or cross dipole antennas. As described previously in FIG. 1, the antennas 52 are located at different positions around the vehicle and provided at different orientations to approximate a desired reception band.

Each antenna 52 is in electrical communication with a low noise amplifier 54. The low noise amplifier 54 receives power from a power supply 62 such as the vehicle battery. The low noise amplifier 54 boosts the signal strength of the satellite signal and provides an amplified signal to a switching circuit 56. The switching circuit 56 selectively provides the amplified signal from each of the antennas 52 to the combining circuit 58 based on an input from the controller 64.

The controller 64 receives environmental information 66 and is configured to manipulate the switching status of the switching circuit 56 based on the environmental information 66. The environmental information 66 may include, for example, the location of the car and the orientation of the car relative to a global coordinate system. The environmental information 66 may be received from a GPS, read from a compass, derived over time based on vehicle direction, or calculated using other commonly known positioning systems. The controller 64 may calculate which combination of amplified signals to provide to the combining circuit 58 based on the environmental information 66.

The controller 64 is in communication with a database 68. The database 68 includes a mapping of satellite receiver performance based on various combinations of the antennas 52 across a range of environmental variables, such as location, orientation, and elevation. Accordingly, the controller 64 uses the mapping to predictively determine an optimal antenna combination and controls which switching circuits 56 provide the selected amplified signals to the combining circuit 58. The switching circuits 56 that do not provide the amplified signal to the combining circuit 58, connect the combining circuit 58 to a terminator 70, such as a termination resistor, that is connected to a reference voltage 72.

The combining circuit 58 phase shifts each of the amplified signals, so that the amplified signals are phase aligned. The signals may then be additively combined and provided to a tuner 60 to generate an audio output signal 74. Alternatively, the combining circuit 58 may be configured to weight each of the amplified signals when they are combined based on the environmental information 66.

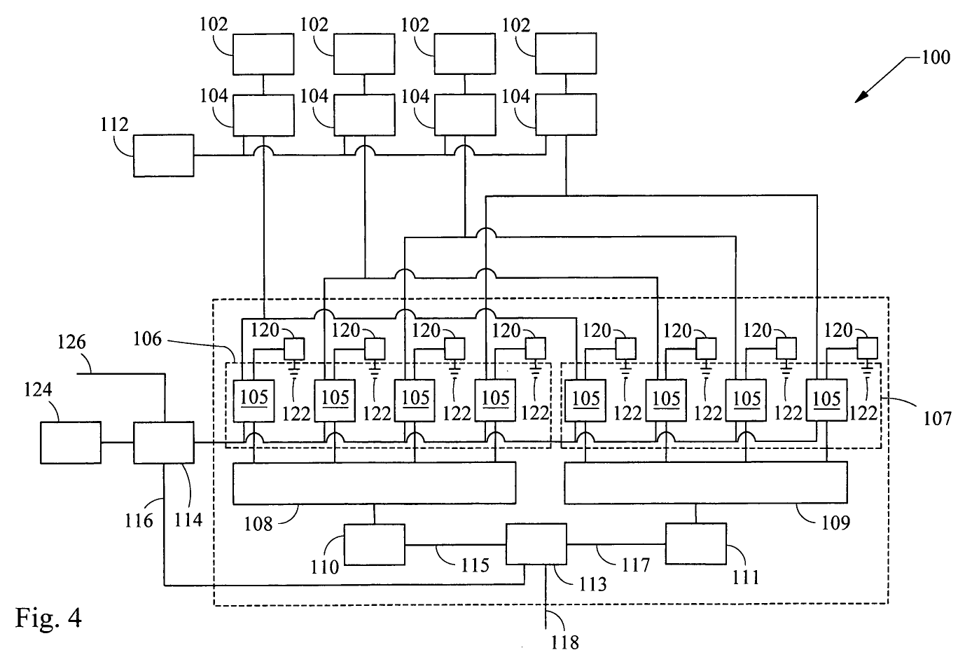

Now referring to FIG. 4, a satellite receiver system in accordance with the present invention is provided and designated by reference numeral 100. The satellite receiver system 100 includes a plurality of antennas 102, low noise amplifiers 104, switching circuits 105, two combining circuits 108 and 109, and two tuners 110 and 111. The antennas 102 are circularly polarized antennas and may be patch, quadra filar helix, or cross dipole antennas.

Each antenna 102 is in electrical communication with a low noise amplifier 104. The low noise amplifier 104 receives power from a power supply 112, such as the vehicle battery. The low noise amplifier 104 boosts the signal strength of the satellite signal and provides an amplified signal to the switching circuits 105. More specifically, the low noise amplifier 104 provides the amplified signal to a switching circuit from a first set 106 of switching circuits 105 and also provides the amplified signal to a switching circuit of the second set 107 of switching circuits 105. Each switching circuit of the first set 106 of switching circuits 105 selectively provides the amplified signal from each of the antennas 102 to a first combining circuit 108 based on an input from the controller 114. Similarly, each switching circuit of the second set 107 of switching circuits 105 selectively provides the amplified signal from each of the antennas 102 to a second combining circuit 109 based on an input from the controller 114. The first combining circuit 108 phase shifts each of the amplified signals received from the first set 106 of switching circuits 105, so that the amplified signals are phase aligned. The amplified signals may then be additively combined and provided to a first tuner 110 to generate a first output signal 115 that is provided to an evaluation circuit 113.

Similarly, the second combining circuit 109 phase shifts each of the amplified signals received from the second set 107 of switching circuits 105, so that the amplified signals are phase aligned. The amplified signals may then be additively combined and provided to second tuner 111 to generate a second output signal 117. The second output signal 117 is provided to the evaluation circuit 113. The evaluation circuit 113 compares the quality of the first output signal 115 and the second output signal 117 and provides signal comparison information 116 to the controller 114. Upon determining the higher quality signal between the first output signal 115 and the second output signal 117, the evaluation circuit 113 provides an audio output signal 118 based on the higher quality signal between the first and second output signals 115, 117. The evaluation circuit 113 may determine the higher quality signal based on signal to noise ratio, bit error rate, or other commonly known techniques including a combination thereof.

The controller 114 receives signal comparison information 116 from an evaluation circuit 113 and is configured to manipulate the switching status of the switching circuit 105 based on the signal comparison information 116. The signal comparison information 116 may include, for example, the signal to noise ratio and a bit error rate information.

The controller 114 receives environmental information 126 and is configured to manipulate the switching status of the switching circuit 105 based on the environmental information 126. The environmental information 126 may include, for example, the location of the car and the orientation of the car relative to a global coordinate system. The environmental information 126 may be received from a GPS, a compass, derived over time based on vehicle direction, or using other commonly known positioning systems. The controller 114 may calculate which combination of amplified signals to provide to the combining circuit 108, 109 based on the environmental information 126. Alternatively, the combining circuits 108, 109 may be configured to weight each of the amplified signals when they are combined based on the environmental information 66.

The controller 114 is in communication with a database 124. The database 124 includes a mapping of satellite receiver performance based on various combinations of the antennas 102 across a range of environmental variables such as location, orientation, and elevation. Accordingly, the controller 114 uses the mapping and the signal comparison information to control which switching circuits 105 provide the selected amplified signals to the combining circuits 108, 109. The switching circuits 105 that do not provide the amplified signal to the combining circuits 108, 109, connect the combining circuits 108, 109 to a terminator 120, such as a termination resistor, that is connected to a reference voltage 122.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I/We claim:

1. A system for receiving a satellite signal, the system comprising:
a plurality of antennas;
a plurality of amplifiers, wherein each amplifier of the plurality of amplifiers is in communication with a corresponding antenna of the plurality of antennas;
a plurality of switching circuits where each switching circuit is in communication with an amplifier of the plurality of amplifiers, each switching circuit being configured to selectively communicate an amplified signal;
a combining circuit configured to phase align each amplified signal from the plurality of amplifiers then combine each amplified signal received by the combining circuit into a combined signal; and
a tuner in communication with the combining circuit to generate an audio signal based on the combined signal.

2. The system according to claim 1, wherein the plurality of switching circuits is configured to selectively communicate each amplified signal based on environmental information.

3. The system according to claim 1, further comprising a controller in communication with each switching circuit of the plurality of switching circuits, the controller being configured to manipulate a switching status of the switching circuit based on environmental information.

4. The system according to claim 3, wherein the controller is configured to receive environmental information, the controller being in communication with a database containing antenna information, wherein the controller is configured to manipulate the switching circuits based on the environmental information and the antenna information.

5. The system according to claim 4, wherein the database contains a mapping of reception bands for the plurality of antennas.

6. The system according to claim 5, wherein the database contains a mapping of a reception band for each antenna of the plurality of antennas.

7. The system according to claim 5, wherein the database contains a mapping of reception bands for combinations of the plurality of antennas.

8. The system according to claim 1, wherein each switching circuit is in communication with a terminator and the switching circuit is configured to selectively connect the combining circuit to one of the plurality of amplifiers or the terminator.

9. The system according to claim 1, wherein the plurality of antennas are circularly polarized antennas.

10. A system for receiving a satellite signal, the system comprising:
a plurality of antennas;
a plurality of amplifiers where each amplifier is in communication with a corresponding antenna of the plurality of antennas;
a first set of switching circuits where each switching circuit is in communication with an amplifier of the amplifiers, each switching circuit being configured to selectively communicate an amplified signal from each amplifier;
a second set of switching circuits where each switching circuit is in communication with an amplifier of the plurality of amplifiers, each switching circuit of the second set of switching circuits being configured to selectively communicate an amplified signal from a corresponding amplifier;
a first combining circuit configured to phase align each amplified signal from the first set of switching circuits then combine each amplified signal received by the first combining circuit into a first combined signal;
a second combining circuit configured to phase align each amplified signal from the second set of switched circuits then combine each amplified signal received by the second combining circuit into a second signal;
a first tuner in electrical communication with the first combining circuit to generate a first output signal based on the first combined signal; and
a second tuner in communication with the second combining circuit to generate a second output signal based on the second combined signal.

11. The system according to claim 10, further comprising:
an evaluation circuit in electrical communication with the first and second tuner to receive the first and second output signal, the evaluation circuit being configured to selectively output the first or second output signal based on signal comparison information.

12. The system according to claim 10, wherein the plurality of switching circuits is configured to selectively communicate each amplified signal based on environmental information.

13. The system according to claim 10, further comprising a controller in communication with each switching circuit of the plurality of switching circuits, the controller being configured to manipulate a switching status of the switching circuit based on environmental information.

14. The system according to claim 11, wherein the controller is configured to manipulate the switching status of the switching circuit based on signal comparison information.

15. The system according to claim 12, wherein the controller is configured to receive environmental information, the controller being in communication with a database containing antenna information, wherein the controller is configured to manipulate the switching circuits based on the environmental information and the antenna information.

16. The system according to claim 15, wherein the database contains a mapping of reception bands for the plurality of antennas.

17. The system according to claim 16, wherein the database contains a mapping of a reception band for each antenna of the plurality of antennas.

18. The system according to claim 16, wherein the database contains a mapping of reception bands for combinations of the plurality of antennas.

19. The system according to claim 10, wherein each switching circuit is in communication with a terminator and the switching circuit is configured to selectively connect the combining circuit to one of the plurality of amplifiers or the terminator.
